(19) United States
(12) Patent Application Publication
(10) Pub. No.: US 2026/0004357 A1
(43) Pub. Date: Jan. 1, 2026

(54) METHOD AND SYSTEM FOR INSURANCE UNDERWRITING AND CLAIMING USING HOUSE IMAGES

(71) Applicant: BEES360, INC., KATY, TX (US)

(72) Inventors: KUN LIU, KATY, TX (US); XIAOQING WU, KATY, TX (US); CHAORAN YANG, SHENZHEN (CN); TIANWU ZANG, SHENZHEN (CN)

(21) Appl. No.: 18/923,715

(22) Filed: Oct. 23, 2024

Related U.S. Application Data
(63) Continuation of application No. PCT/CN2024/103899, filed on Jul. 5, 2024.

(30) Foreign Application Priority Data
Jun. 26, 2024 (CN) 202410836829.9

(51) Int. Cl. G06Q 40/08; G06Q 10/10

(52) U.S. Cl. CPC G06Q 40/08; G06Q 10/10

(57) ABSTRACT

The present application relates to a method for insurance underwriting and claiming using house images, which includes: performing artificial intelligence detection and determination in real time during a process of taking house photos, and uploading taken house photos to a cloud end; wherein the house photos include a roof photo and/or photos of inside and outside of the house; performing artificial intelligence measurement and damage assessment based on the uploaded house photos, and generating an underwriting or claiming report. The present application further relates to a system for insurance underwriting and claiming using house images. The present application realizes high-efficiency and accurate collection and analysis for house images, and provides more comprehensive and reliable data support for insurance underwriting and claiming.

### CROSS REFERENCE TO RELATED APPLICATIONS

The present disclosure is a U.S. continuation of co-pending International Patent Application Number PCT/CN2024/103899, filed on Jul. 5, 2024, and claims the benefit and priority of Chinese Patent Application Number 202410836829.9, filed on Jun. 26, 2024. The entire contents of the above-identified applications are incorporated herein by reference.

### TECHNICAL FIELD

The present invention relates to a method and system for insurance underwriting and claiming using house images.

### BACKGROUND

In current housing insurance underwriting and claiming processes, there are some significant drawbacks:

(1) Cumbersome and time-consuming inspection procedures. Traditional housing inspections usually require manual inspection by professionals. Especially in inspections relating to roofs, loss adjusters often need to use ladders to climb up to roofs and walk back and forth for 30-75 minutes on the roofs to search for damage points one by one. These processes are time-consuming and laborious, especially in large-scale insurance underwriting and claims, they may lead to low efficiency and increased costs.

(2) Subjectivity and inconsistency. Relying on manual inspection results in subjectivity and inconsistency. Different loss adjusters may have difference in risk assessments of houses, which may lead to disputes for insurance companies when underwriting and claiming.

(3) Low efficiency in data collection and processing. Under traditional methods, data collection and processing often require time and human resources, and are prone to generate omissions or errors, thereby affecting accuracy and efficiency of insurance underwriting and claims.

(4) When photographers use consumer grade UAV and mobile phones to take pictures of roofs and houses, there are often issues such as poor image quality, non-standard shooting angles, missing risk items or damage items that are of concern to the insurance industry, etc. Efficiency and accuracy of identifying risks or damages from images and writing inspection reports in the future are greatly reduced.

### SUMMARY OF THE DISCLOSURE

In view of this, it is necessary to provide a method and system for insurance underwriting and claiming using house images.

The present invention provides a method for insurance underwriting and claiming using house images, the method comprises the following steps: a, performing artificial intelligence detection and determination in real time during a process of taking house photos, and uploading taken house photos to a cloud end; wherein the house photos comprise a roof photo and/or photos of inside and outside of the house; b, performing artificial intelligence measurement and damage assessment based on the uploaded house photos, and generating an underwriting or claiming report.

Preferably, before the step a, the method further comprises: when a detection requirement of an insurance company comprises a roof, dispatching an unmanned aerial vehicle (UAV) to take photos of the roof.

Preferably, before the step a, the method further comprises: when a detection requirement of an insurance company comprises inside and outside of a house, using a mobile phone to take photos of inside and outside of the house.

Preferably, the step a comprises: step S31: obtaining house photos taken by a photographer; step S32: calling an image algorithm or an artificial intelligence model to perform real-time determination, wherein the real-time determination comprises: determining image clarities, determining far and close degrees of image sizes, determining whether an image comprises an entire wall body, and determining whether an image is a roof or a facade; step S33, generating a detection result and displaying it on a user interface.

Preferably, the step S33 comprises: if it is determined that image quality of the photographer is not up to standard or that shooting was not performed according to instruction, displaying prompt information; providing the photographer with corresponding suggestion of re-shooting or ignoring the prompt information after confirming that shooting is correct.

Preferably, the step b comprises: step S41, receiving uploaded house photos; step S42, performing pre-processing for the house photos, wherein the pre-processing comprises denoising and adjusting brightness and contrast; step S43, calling an artificial intelligence model to perform measurement and damage assessment for pre-processed house photos; extracting image features and analyzing to recognize risk items or damage items; step S44, generating an underwriting or claiming report; step S45, storing processed data and updating database.

Preferably, the step S44 comprises: forming a claiming report based on the measurement and damage assessment; if initial review is not passed, notifying missed photo information, and performing photo data collection for the second time.

The present invention provides a system for insurance underwriting and claiming using house images, the system comprises a shooting process module and a cloud module, wherein: the shooting process module is configured to perform artificial intelligence detection and determination in real time during a process of taking house photos, and upload taken house photos to a cloud end; wherein the house photos comprise a roof photo and/or photos of inside and outside of the house; the cloud module is configured to perform measurement and damage assessment based on the uploaded house photos, and generate an underwriting or claiming report.

Preferably, the system further comprises a roof shooting module; the roof shooting module is configured to: when a detection requirement of an insurance company comprises a roof, dispatch an unmanned aerial vehicle (UAV) to take photos of the roof.

Preferably, the system further comprises a house inside and outside shooting module; the house inside and outside shooting module is configured to: when a detection requirement of an insurance company comprises inside and outside of a house, use a mobile phone to take photos of inside and outside of the house.

The present invention can greatly improve quality of images taken by photographers, reduce probability of deploying a task twice, and greatly reduce time from an insurance company initiating a detection request to a report being returned to the insurance company; decision-making efficiency of the insurance company is accelerated and waiting time for homeowners is reduced, thereby significantly improving customer satisfaction. The present invention realizes efficient and accurate collection and analysis for house images, and provides more comprehensive and reliable data support for insurance underwriting and claims. Specifically:

Firstly, for roof inspection, through pre-designed inspection areas, inspection routes, and planning of different inspection heights (overview map shooting, 360 degree flight shooting, overall claim object shooting, and close range shooting for claim object details), quality and completeness of photos taken by UAV are greatly improved and can fully cover multi-scale and multi-resolution roof risk items and damage items.

Secondly, through applications deployed on consumer grade mobile phones, photographers can capture exterior facades of houses with different angles, distances, and accuracies through pre-set processes. Lightweight image processing algorithms and models deployed in the applications can help photographers follow the processes and generate prompts when image quality is too low or the processes are not conformed, thereby greatly reducing probability of photographers uploading useless images.

Finally, through artificial intelligence models deployed in the cloud, it is possible to automatically detect risk items and damage items of concern to the insurance industry through features extracted from images, thereby reducing proportion and time of manually recognizing these items, such that a complete detection report can be generated within a few hours after uploading by a photographer.

### BRIEF DESCRIPTION OF THE DRAWINGS

FIG. 1 is a flow chart of a method for insurance underwriting and claiming using house images of the present invention.

FIG. 2 is a hardware architecture diagram of a system for insurance underwriting and claiming using house images of the present invention.

FIG. 3 is a schematic diagram of a sequence of flight paths in an embodiment of the present invention.

### DETAILED DESCRIPTION

The present invention is further illustrated in detail below in accompany with drawings and specific embodiments.

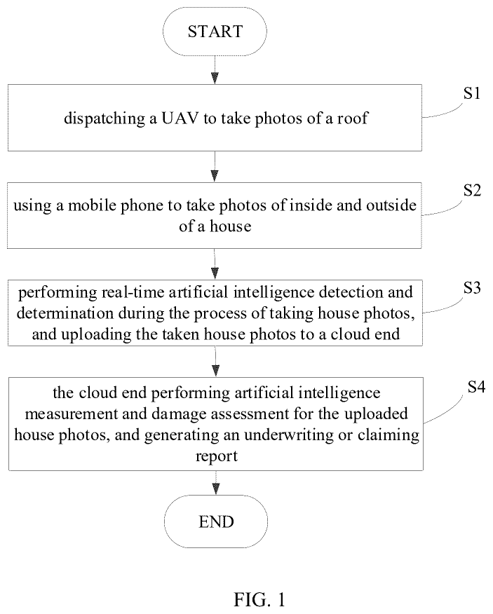

Referring to FIG. 1, which is an operating flow chart of a preferred embodiment of a method for insurance underwriting and claiming using house images of the present invention.

Step S1, dispatching an unmanned aerial vehicle (UAV) to take photos of a roof; wherein the UAV can be a consumer grade UAV, the consumer grade UAV includes a consumer grade single lens UAV without special hardware such as a laser radar.

In this embodiment, by training and dispatching consumer grade UAV pilots, UAV equipments are used for aerial photography for houses, especially for inspecting roofs. This can obtain comprehensive roof conditions, including potential risks and damage situations, without the need for personnel to directly climb onto roofs. If an inspection requirement of an insurance company does not include a roof, this step is not necessary and can be skipped. Specifically:

Step S11: starting a UAV and performing system self-test.

Step S12: setting flight paths and task areas. Among them, the flight paths include overview map shooting, 360 degree flight shooting, overall claim object shooting, and close range shooting for claim object details.

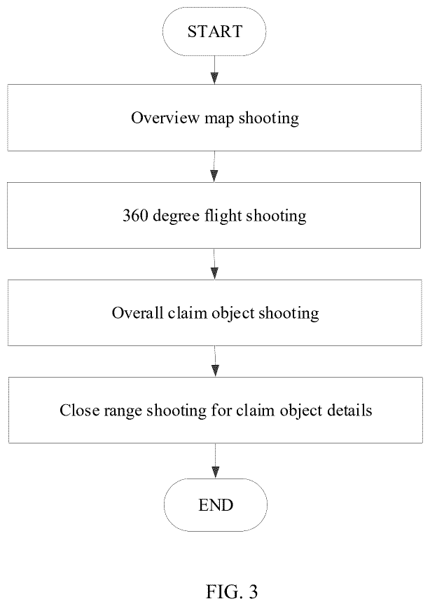

In this embodiment, a sequence of the flight paths (referring to FIG. 3) is overview map shooting, 360 degree flight shooting, overall claim object shooting, and close range shooting for claim object details, thereby achieving preferable effect. In other embodiments, this sequence of the flight paths can also be varied, the present invention can also be implemented.

Among them, the overview map shooting requires a whole house to be covered by an image, and a deployed algorithm can segment the image in real time to detect whether the entire house is within the image. The 360 degree flight shooting requires S-shaped or Zigzag shaped shooting, wherein each image has a certain degree of overlap with a previous image. A deployed algorithm can monitor in real time whether the requirement is met and have a basic judgment on the distance of flight. In other embodiments, this step can also be skipped and detailed shooting can be performed directly. The overall claim object shooting requires a camera's imaging plane to be as parallel as possible to a corresponding roof slope, and verification and reminding are performed through a built-in real-time algorithm; at the same time, by using a neural network model, there is a rough estimate for the distance to the roof, so that a shooting distance is within an appropriate range. In other embodiments, this step can also be skipped and detailed shooting can be performed directly. Requirement of the close range shooting for claim object details are similar to those of the overall claim object shooting, but the resolution requirement is higher and damages need to be clearly visible.

Step S13: the UAV takes off and cruises according to a given flight area and route.

Step S14: A pilot monitors the flight status, takes photos during cruising, and remotely controls the UAV if necessary.

Step S15: The UAV completes the flight task and lands safely.

Step S2, using a mobile phone to take photos of inside and outside of a house. If an inspection requirement of an insurance company does not include inside and outside of a house, this step is not necessary and can be skipped. Among them, the mobile phone can be a consumer grade mobile phone, the consumer grade mobile phone includes a consumer grade mobile phone without special hardware such as a gyroscope.

In this embodiment, a consumer grade mobile phone device is used to take photos of outside of a house, including exterior structures, exterior walls, doors and windows, a courtyard, a rainwater drainage system, a ventilation system, and other parts of the house. The photos provide more detailed and comprehensive information about the house, which helps identify potential risk items or damage items for claims. For taking photos of the roof and the outside, in some cases, with authorization of the homeowner, they can even be taken when the homeowner is out. Even if the homeowner is at home, the entire shooting process does not require the homeowner to open the door and communicate and coordinate with a photographer.

A consumer grade mobile phone device is used to take photos of inside of a house, including internal structures, water leakage, aging pipes, and other parts of the house. For internal shooting, it is necessary to comply with requirements of insurance companies and consent of the homeowner, and it is necessary to make an appointment with the homeowner for inspection.

### Specifically:

Step S21: installing and opening a mobile application program.

Step S22: selecting a shooting mode and a shooting position. The shooting mode includes an internal shooting mode and an external shooting mode.

Step S23: according to indication of the application program, aiming at a target and shooting.

Step S24, returning to a main interface or continuing to shoot other positions.

This embodiment develops a mobile application program (APP) to implement capturing and uploading photos inside and outside a house through a mobile phone camera. A user interface is designed so as to enable users to easily shoot different parts according to indications. After all photos have been taken and preliminarily checked, the photos are uploaded to a cloud server.

When a photographer starts shooting exterior of a house, the application program will indicate performing a series of shots for each individual house. For each house to be photographed, the photographer needs to respectively shoot from eight different angles, namely front, front right, right, right rear, rear, rear left, left, and left front. For the four angles front right, right rear, rear left, and left front, only two walls and their intersecting edges and corners need to be exposed. For the four angles front, back, left, and right, it is necessary to first take a comprehensive photo covering an entire wall, and then take a series of close-up photos from one side of the wall to the other, so that each close-up photo has a certain overlapping area. When the photographer discovers some common risk items or damage items in insurance, such as damage to doors and windows, it is necessary to perform separated focused shooting for the risk items or damage items.

When a photographer starts shooting interior of a house, the application program will indicate performing a series of shots for individual rooms and important objects. For claims business, it is necessary to shoot damaged rooms, including overall claim object shooting and close range shooting for claim object details. For underwriting business, most rooms require independent shooting to collect existing damage, aging, and other information. The important objects include but are not limited to air conditioning and ventilation systems, drainage and sewage systems, pipelines, water and electricity meters, water heaters, stairs, doors and windows, etc. According to customers' requirements, the close range shooting for claim object details includes shooting a label, a brand, a serial number, a production year, and other information of an object. In other embodiments, it is also possible to collect size information of each room to generate a floor plan based on a customer's requirement.

This embodiment deploys real-time image processing algorithms and models based on computer vision technology on an application program end (see step S3 for details). When a photographer follows indication of the application program and presses a button to take a photo, an image processing algorithm deployed in the application program performs preliminary analysis for the quality of the captured photo. For example, if the photo is blurry and not clear enough, or if the distance is too far when taking a close-up photo, or if a part of an exterior wall is missed when taking an overall photo of a house, the photographer will be prompted to re-shoot or change an angle to shoot.

This embodiment deploys an artificial intelligence model based on computer vision technology in a cloud end (see step S4 for details). When a photographer performs focused shooting for common risk items or damage items in insurance, such as doors and windows, drainage pipes, water and electricity meters, swimming pools, trees, edges of houses and roofs, etc., the photographer can choose to use the application program to annotate these objects or areas. If the mobile phone is connected to the internet in real-time, the mobile application program can also use the artificial intelligence model to automatically annotate images by contacting a remote server. The photographer can choose to edit information automatically annotated by the model.

The photographer uploads complete photos after identifying and annotating damage of claim objects to a claim platform deployed in the cloud end.

Step S3, performing real-time artificial intelligence detection and determination during the process of taking house photos, and uploading the taken house photos to the cloud end; using image processing and computer vision technology to perform real-time analyzing and processing for the photos to extract key information and features. For example, providing prompts to UAV pilots during processes of using UAV or mobile phones to shoot, such as whether relevant objects are included, whether quality and angles of photos meet standards, etc., thereby improving shooting efficiency and reducing invalid photos. Among them, the house photos include: roof photos, interior and exterior photos of the house.

### Specifically:

Step S31: obtaining data of photos just taken through an application program by a photographer.

Step S32: calling an image algorithm or an artificial intelligence model to perform real-time determination, wherein the real-time determination includes: determining image clarities, determining far and close degrees of image sizes, determining whether an image includes an entire wall body, determining whether an image is a roof or a facade, etc.

Step S33, generating a detection result and displaying it on a user interface. If certain determination indicate that the photographer's image quality is not up to standard or that the shooting was not performed according to indication of the application program, relevant prompt messages will be displayed. The photographer will be advised to reshoot or ignore the prompt messages after confirming that the shooting is correct.

This embodiment develops algorithms based on image recognition and artificial intelligence models based on deep learning, which are used for real-time detection of photos' clarity and distance, classification of roofs and facades, whether an entire wall body is included, etc.

The artificial intelligence models are deployed on consumer grade mobile phones and are called by application programs to achieve quick determination.

This embodiment displays results on user interfaces and provides corresponding suggestions or processing solutions.

Step S4: the cloud end performs artificial intelligence measurement and damage assessment based on the uploaded house photos: using artificial intelligence technology to perform analysis and identification for the taken photos. The analysis and identification can identify common risk items or damage items, such as cracks in roof tiles, water leakage, and damage to house structures. The risk items or damage items are used to write high-quality insurance checking reports.

### Specifically:

Step S41: receiving uploaded house photos.

Step S42: performing pre-processing for the house photos, wherein the pre-processing includes denoising, adjusting brightness and contrast, etc.

Step S43: calling an artificial intelligence model to perform analysis and identification: extracting image features and analyzing to recognize risk items or damage items.

Step S4: generating an underwriting or claiming report.

Step S45: storing processed data and updating database.

This embodiment deploys a cloud server and a storage system for receiving and processing uploaded photo data.

The cloud server is deployed with image processing algorithms based on artificial intelligence, a claim platform performs 3D point cloud reconstruction and denoising section processing for complete photos of the roof and the exterior walls of the house, thereby restoring 3D images of the roof and the exterior of the house.

The claim platform performs measurement and damage assessment for the processed complete photos of the roof and the exterior walls of the house, and generates a claims report; if a preliminary review is not passed, the claim platform informs a UAV of missed photo information and controls the UAV to perform photo data collection for the second time.

This embodiment configures a database system to store processed data and generated reports.

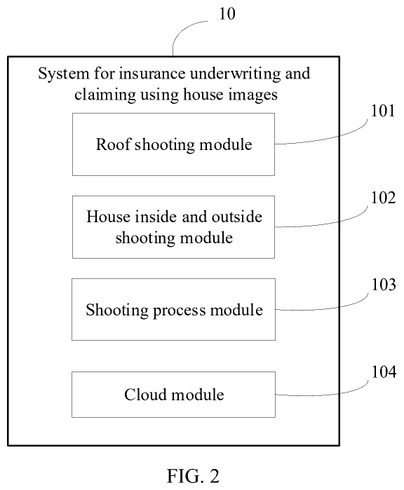

Referring to FIG. 2, which is a hardware architecture diagram of a system 10 for insurance underwriting and claiming using house images of the present invention. The system includes: a roof shooting module 101, a house inside and outside shooting module 102, a shooting process module 103, and a cloud module 104. Among them:

The roof shooting module 101 is configured to dispatch a UAV to take photos of a roof; wherein the UAV can be a consumer grade UAV, the consumer grade UAV includes a consumer grade single lens UAV without special hardware such as a laser radar.

In this embodiment, by training and dispatching consumer grade UAV pilots, UAV equipments are used for aerial photography for houses, especially for inspecting roofs. This can obtain comprehensive roof conditions, including potential risks and damage situations, without the need for personnel to directly climb onto roofs. If an inspection requirement of an insurance company does not include a roof, this module is not necessary. Specifically:

The roof shooting module 101 starts a UAV and performs system self-test, and then sets flight paths and task areas. Among them, the flight paths include: overview map shooting, 360 degree flight shooting, overall claim object shooting, and close range shooting for claim object details.

In this embodiment, a sequence of the flight paths is overview map shooting, 360 degree flight shooting, overall claim object shooting, and close range shooting for claim object details, thereby achieving preferable effect. In other embodiments, this sequence of the flight paths can also be varied, the present invention can also be implemented.

Among them, the overview map shooting requires a whole house to be covered by an image, and a deployed algorithm can segment the image in real time to detect whether the entire house is within the image. The 360 degree flight shooting requires S-shaped or Zigzag shaped shooting, wherein each image has a certain degree of overlap with a previous image. A deployed algorithm can monitor in real time whether the requirement is met and have a basic judgment on the distance of flight. In other embodiments, this step can also be skipped and detailed shooting can be performed directly. The overall claim object shooting requires a camera's imaging plane to be as parallel as possible to a corresponding roof slope, and verification and reminding are performed through a built-in real-time algorithm; at the same time, by using a neural network model, there is a rough estimate for the distance to the roof, so that a shooting distance is within an appropriate range. In other embodiments, this step can also be skipped and detailed shooting can be performed directly. Requirement of the close range shooting for claim object details are similar to those of the overall claim object shooting, but the resolution requirement is higher and damages need to be clearly visible.

The UAV takes off and cruises according to a given flight area and route. A pilot monitors the flight status, takes photos during cruising, and remotely controls the UAV if necessary. The UAV completes the flight task and lands safely.

The house inside and outside shooting module 102 is configured to use a mobile phone to take photos of inside and outside of a house. If an inspection requirement of an insurance company does not include inside and outside of a house, this module is not necessary. Among them, the mobile phone can be a consumer grade mobile phone, the consumer grade mobile phone includes a consumer grade mobile phone without special hardware such as a gyroscope.

In this embodiment, a consumer grade mobile phone device is used to take photos of outside of a house, including exterior structures, exterior walls, doors and windows, a courtyard, a rainwater drainage system, a ventilation system, and other parts of the house. The photos provide more detailed and comprehensive information about the house, which helps identify potential risk items or damage items for claims. For taking photos of the roof and the outside, in some cases, with authorization of the homeowner, they can even be taken when the homeowner is out. Even if the homeowner is at home, the entire shooting process does not require the homeowner to open the door and communicate and coordinate with a photographer.

A consumer grade mobile phone device is used to take photos of inside of a house, including internal structures, water leakage, aging pipes, and other parts of the house. For internal shooting, it is necessary to comply with requirements of insurance companies and consent of the homeowner, and it is necessary to make an appointment with the homeowner for inspection.

The following are specifically included:
installing and opening a mobile application program;
selecting a shooting mode and a shooting position; wherein the shooting mode includes an internal shooting mode and an external shooting mode;
according to indication of the application program, aiming at a target and shooting.
confirming quality of photos and uploading them to a cloud server;
returning to a main interface or continuing to shoot other positions.

This embodiment develops a mobile application program (APP) to implement capturing and uploading photos inside and outside a house through a mobile phone camera. A user interface is designed so as to enable users to easily shoot different parts according to indications. After all photos have been taken and preliminarily checked, the photos are uploaded to a cloud server.

When a photographer starts shooting exterior of a house, the application program will indicate performing a series of shots for each individual house. For each house to be photographed, the photographer needs to respectively shoot from eight different angles, namely front, front right, right, right rear, rear, rear left, left, and left front. For the four angles front right, right rear, rear left, and left front, only two walls and their intersecting edges and corners need to be exposed. For the four angles front, back, left, and right, it is necessary to first take a comprehensive photo covering an entire wall, and then take a series of close-up photos from one side of the wall to the other, so that each close-up photo has a certain overlapping area. When the photographer discovers some common risk items or damage items in insurance, such as damage to doors and windows, it is necessary to perform separated focused shooting for the risk items or damage items.

When a photographer starts shooting interior of a house, the application program will indicate performing a series of shots for individual rooms and important objects. For claims business, it is necessary to shoot damaged rooms, including overall claim object shooting and close range shooting for claim object details. For underwriting business, most rooms require independent shooting to collect existing damage, aging, and other information. The important objects include but are not limited to air conditioning and ventilation systems, drainage and sewage systems, pipelines, water and electricity meters, water heaters, stairs, doors and windows, etc. According to customers' requirements, the close range shooting for claim object details includes shooting a label, a brand, a serial number, a production year, and other information of an object. In other embodiments, it is also possible to collect size information of each room to generate a floor plan based on a customer's requirement.

The shooting process module 103 is configured to perform real-time artificial intelligence detection and determination during the process of taking house photos, and upload the taken house photos to the cloud end; image processing and computer vision technology are used to perform real-time analyzing and processing for the photos to extract key information and features. For example, prompts are provided to UAV pilots during processes of using UAV or mobile phones to shoot, such as whether relevant objects are included, whether quality and angles of photos meet standards, etc., thereby improving shooting efficiency and reducing invalid photos. Among them, the house photos include: roof photos, interior and exterior photos of the house. Specifically:

The shooting process module 103 obtains data of photos just taken through an application program by a photographer.

The shooting process module 103 calls an image algorithm or an artificial intelligence model to perform real-time determination, wherein the real-time determination includes: determining image clarities, determining far and close degrees of image sizes, determining whether an image includes an entire wall body, determining whether an image is a roof or a facade, etc.

The shooting process module 103 generates a detection result and displays it on a user interface. If certain determination indicate that the photographer's image quality is not up to standard or that the shooting was not performed according to indication of the application program, relevant prompt messages will be displayed. The photographer will be advised to reshoot or ignore the prompt messages after confirming that the shooting is correct.

This embodiment develops algorithms based on image recognition and artificial intelligence models based on deep learning, which are used for real-time detection of photos' clarity and distance, classification of roofs and facades, whether an entire wall body is included, etc.

The artificial intelligence models are deployed on consumer grade mobile phones and are called by application programs to achieve quick determination.

This embodiment displays results on user interfaces and provides corresponding suggestions or processing solutions.

The cloud module 104 is configured to perform artificial intelligence measurement and damage assessment based on the uploaded house photos, and generate an underwriting or claim report: artificial intelligence technology is used to perform analysis and identification for the taken photos. The analysis and identification process can identify common risk items or damage items, such as cracks in roof tiles, water leakage, and damage to house structures. The risk items or damage items are used to write high-quality insurance checking reports.

### Specifically:

The cloud module 104 receives uploaded house photos.

The cloud module 104 pre-processes the photos, wherein the pre-processing includes denoising, adjusting brightness and contrast, etc.

The cloud module 104 calls an artificial intelligence model to perform analysis and identification: extracting image features and analyzing to recognize risk items or damage items.

The cloud module 104 generates an underwriting or claiming report.

The cloud module 104 stores processed data and updates database.

This embodiment deploys a cloud server and a storage system for receiving and processing uploaded photo data.

The cloud server is deployed with image processing algorithms based on artificial intelligence, a claim platform performs 3D point cloud reconstruction and denoising section processing for complete photos of the roof and the exterior walls of the house, thereby restoring 3D images of the roof and the exterior of the house.

The claim platform performs measurement and damage assessment for the processed complete photos of the roof and the exterior walls of the house, and generates a claims report; if a preliminary review is not passed, the claim platform informs a UAV of missed photo information and controls the UAV to perform photo data collection for the second time.

This embodiment configures a database system to store processed data and generated reports.

In the present application, house inspection is performed by dispatching consumer grade UAV pilots, in combination with shooting by consumer grade mobile phones inside and outside the house; the photos are first pre-judged using image processing algorithms and models deployed in local application programs to ensure clarity and quality of the photos and that photographers has taken qualified photos according to instructions. After all photos are taken, the photos are uploaded to the cloud end for post-processing, and image processing algorithms and artificial intelligence technology are used to perform analysis and identification for the images, so as to identify risk items of insurance or damaged items of claim. This can improve efficiency and accuracy of house inspection processes, reduce interference of human subjective factors, and accelerate speed and accuracy of collecting and processing data, thereby improving efficiency and accuracy of insurance underwriting and claiming, and bringing better service experience to insurance companies and customers.

Although the present invention has been described with reference to the current preferred embodiments, those skilled in the art should understand that the above preferred embodiments are only used to illustrate the present invention and are not intended to limit the protection scope of the present invention. Any modifications, equivalent replacements, improvements, and so on made within the spirit and principles of the present invention should be included in the protection scope of the claims of the present invention.

What is claimed is:

1. A method for insurance underwriting and claiming using house images, wherein the method comprises the following steps:
a, performing artificial intelligence detection and determination in real time during a process of taking house photos, and uploading taken house photos to a cloud end; wherein the house photos comprise a roof photo and/or photos of inside and outside of the house;
b, performing artificial intelligence measurement and damage assessment based on the uploaded house photos, and generating an underwriting or claiming report.

2. The method for insurance underwriting and claiming using house images according to claim 1, wherein before the step a, the method further comprises:
when a detection requirement of an insurance company comprises a roof, dispatching an unmanned aerial vehicle (UAV) to take photos of the roof; wherein the UAV comprises a consumer grade UAV.

3. The method for insurance underwriting and claiming using house images according to claim 1, wherein before the step a, the method further comprises:
when a detection requirement of an insurance company comprises inside and outside of a house, using a mobile phone to take photos of inside and outside of the house; wherein the mobile phone comprises a consumer grade mobile phone.

4. The method for insurance underwriting and claiming using house images according to claim 1, wherein the step a comprises:
step S31: obtaining house photos taken by a photographer;
step S32: calling an image algorithm or an artificial intelligence model to perform real-time determination, wherein the real-time determination comprises: determining image clarities, determining far and close degrees of image sizes, determining whether an image comprises an entire wall body, and determining whether an image is a roof or a facade;
step S33, generating a detection result and displaying it on a user interface.

5. The method for insurance underwriting and claiming using house images according to claim 4, wherein the step S33 comprises:
if it is determined that image quality of the photographer is not up to standard or that shooting was not performed according to instruction, displaying prompt information; providing the photographer with corresponding suggestion of re-shooting or ignoring the prompt information after confirming that shooting is correct.

6. The method for insurance underwriting and claiming using house images according to claim 1, wherein the step b comprises:
step S41, receiving uploaded house photos;
step S42, performing pre-processing for the house photos, wherein the pre-processing comprises denoising and adjusting brightness and contrast;
step S43, calling an artificial intelligence model to perform measurement and damage assessment for pre-processed house photos; extracting image features and analyzing to recognize risk items or damage items;
step S44, generating an underwriting or claiming report;
step S45, storing processed data and updating database.

7. The method for insurance underwriting and claiming using house images according to claim 6, wherein the step S44 comprises:
forming a claiming report based on the measurement and damage assessment; if initial review is not passed, notifying missed photo information, and performing photo data collection for the second time.

8. A system for insurance underwriting and claiming using house images, wherein the system comprises a shooting process module and a cloud module, wherein:
the shooting process module is configured to perform artificial intelligence detection and determination in real time during a process of taking house photos, and upload taken house photos to a cloud end; wherein the house photos comprise a roof photo and/or photos of inside and outside of the house;
the cloud module is configured to perform measurement and damage assessment based on the uploaded house photos, and generate an underwriting or claiming report.

9. The system for insurance underwriting and claiming using house images according to claim 8, wherein the system further comprises a roof shooting module;
the roof shooting module is configured to: when a detection requirement of an insurance company comprises a roof, dispatch an unmanned aerial vehicle (UAV) to take photos of the roof.

10. The system for insurance underwriting and claiming using house images according to claim 8, wherein the system further comprises a house inside and outside shooting module;
the house inside and outside shooting module is configured to: when a detection requirement of an insurance company comprises inside and outside of a house, use a mobile phone to take photos of inside and outside of the house.
